(19) United States
(12) Patent Application Publication
(10) Pub. No.: US 2026/0011756 A1
(43) Pub. Date: Jan. 8, 2026

(54) Fuel Cell System

(71) Applicants: HYUNDAI MOTOR COMPANY, Seoul (KR); KIA CORPORATION, Seoul (KR)

(72) Inventor: Jae Kwon Jung, Hwaseong-si (KR)

(73) Assignees: HYUNDAI MOTOR COMPANY, Seoul (KR); KIA CORPORATION, Seoul (KR)

(21) Appl. No.: 18/955,248

(22) Filed: Nov. 21, 2024

(30) Foreign Application Priority Data
Jul. 8, 2024 (KR) 10-2024-0089862

(51) Int. Cl. H01M 8/04007; H01M 8/04119; H01M 8/04701; H01M 8/04746

(52) U.S. Cl. CPC H01M 8/04074; H01M 8/04134; H01M 8/04723; H01M 8/04776

(57) ABSTRACT

Proposed is a fuel cell system, including a fuel cell stack connected to an intake line and an exhaust line, an air compressor connected to the intake line, and a heat energy storage part provided between the fuel cell stack and the air compressor on the intake line and absorbing and storing heat from the air on the intake line through a thermochemical reaction and releasing moisture into the air on the intake line.

### CROSS-REFERENCE TO RELATED APPLICATION

The present application claims priority to Korean Patent Application No. 10-2024-0089862, filed Jul. 8, 2024, the entire contents of which is incorporated herein for all purposes by this reference.

### TECHNICAL FIELD

The present disclosure relates to a fuel cell system that can manage an operating environment of a fuel cell stack through a thermochemical reaction.

### BACKGROUND

A fuel cell is a device that converts chemical energy of a fuel into electrical energy through an oxidation-reduction reaction of hydrogen and oxygen supplied from a hydrogen supply device and an air supply device, respectively, and includes a fuel cell stack for producing electricity, and a cooling system for cooling the fuel cell stack.

In other words, hydrogen is supplied to an anode of the fuel cell stack, and an oxidation reaction in which hydrogen is oxidized occurs at the anode to generate hydrogen ions (protons) and electrons. At this time, the protons and electrons generated at the anode flow to a cathode through an electrolyte membrane and a separator, respectively. At the cathode, water is generated through an electrochemical reaction involving the protons and the electrons having been flowed from the anode, and oxygen contained in the air, and this flow of electrons generates electricity.

In a fuel cell system that utilizes electrical energy generated through an electrochemical reaction of a fuel cell in a fuel cell vehicle, a flow rate flowing into a fuel cell stack is controlled differently depending on required output power. To this end, an air compressor may be provided at an inlet of the fuel cell system.

In a high-output power section where the required output power is high, the air compressor may be controlled at a relatively high driving speed to supply more oxygen to the fuel cell stack. In a low-output power section where the required output power is low, the air compressor may be controlled at a relatively low driving speed.

Meanwhile, heat may be generated during the operation of the air compressor as described above, which may affect the temperature of air supplied to the fuel cell stack.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and one objective of the present disclosure is to provide a fuel cell system that can efficiently manage an operating environment of a fuel cell stack through a thermochemical reaction.

The objectives of the present disclosure are not limited to those mentioned above, and other objectives not mentioned will be clearly understood by those skilled in the art from the description provided hereinafter.

In order to achieve the above objective, according to one aspect of the present disclosure, there is provided a fuel cell system, including a fuel cell stack connected to an intake line through which air is introduced and an exhaust line through which air is discharged, an air compressor connected to the intake line, and configured to compress external air and supply the compressed external air to the fuel cell stack, and a heat energy storage part provided between the fuel cell stack and the air compressor on the intake line, and configured to absorb and store heat from the air on the intake line through a thermochemical reaction and release moisture into the air on the intake line.

For example, the fuel cell system may further include a first valve provided between the air compressor and the heat energy storage part on the intake line and configured to selectively connect the air compressor and the heat energy storage part depending on its opening state.

For example, the fuel cell system may further include a controller configured to control the opening state of the first valve based on a driving speed of the air compressor.

For example, when the driving speed of the air compressor is equal to or greater than a preset first reference speed, the controller may control the opening state of the first valve so that the air compressor and the heat energy storage part are connected to each other on the intake line.

For example, when the driving speed of the air compressor is less than a preset second reference speed that is preset to a value equal to or less than the first reference speed, the controller may control the opening state of the first valve so that the air compressor and the heat energy storage part are disconnected from each other on the intake line.

For example, when a preset time elapses after the air compressor and the heat energy storage part are connected to each other on the intake line, the controller may control the opening state of the first valve so that the air compressor and the heat energy storage part are disconnected from each other on the intake line.

For example, the fuel cell system may further include a heat exchanger disposed in parallel with the heat energy storage part on the intake line between the fuel cell stack and the air compressor, and the first valve may connect the air compressor to at least one of the heat energy storage part and the heat exchanger on the intake line depending on its opening state.

For example, the heat energy storage part and the heat exchanger may be arranged in series on a coolant line through which a coolant for cooling the fuel cell stack flows.

For example, the heat energy storage part may be connected to the exhaust line, may be provided on a coolant line through which a coolant for cooling the fuel cell stack flows, and may absorb moisture from the air on the exhaust line through the thermochemical reaction and release the stored heat into the coolant.

For example, the fuel cell system may further include a second valve provided between the fuel cell stack and the heat energy storage part on the exhaust line and configured to selectively connect the fuel cell stack and the heat energy storage part depending on its opening state.

For example, the fuel cell system may further include a controller configured to control the opening state of the second valve based on a temperature of the coolant.

For example, when the temperature of the coolant is less than a preset first reference temperature, the controller may control the opening state of the second valve so that the fuel cell stack and the heat energy storage part are connected to each other on the exhaust line.

For example, when the temperature of the coolant is equal to or greater than a preset second reference temperature that is preset to a value equal to or greater than the first reference temperature, the controller may control the opening state of the second valve so that the fuel cell stack and the heat energy storage part are disconnected from each other on the exhaust line.

For example, when the heat energy storage part is in a state of absorbing and storing heat from the air on the intake line, the controller may control the opening state of the second valve so that the fuel cell stack and the heat energy storage part are connected to each other on the exhaust line.

For example, when a preset time elapses after the fuel cell stack and the heat energy storage part are connected to each other on the exhaust line, the controller may control the opening state of the second valve so that the fuel cell stack and the heat energy storage part are disconnected from each other on the exhaust line.

For example, the second valve may form a path through which the air on the exhaust line is discharged by bypassing the heat energy storage part depending on its opening state.

For example, the fuel cell system may further include a heat exchanger disposed in series with the heat energy storage part on the coolant line, and the heat energy storage part may be disposed in front of the heat exchanger in a flow direction of the coolant.

For example, the thermochemical reaction may occur through lithium hydroxide (LiOH) filled inside the heat energy storage part.

According to various embodiments of the present disclosure as described above, it is possible to efficiently manage an operating environment of a fuel cell stack through a thermochemical reaction.

In particular, through heat absorption and moisture release using the thermochemical reaction, it is possible to alleviate overheating and drying of the fuel cell stack in a high-output power section, and alleviate output power limitations to prevent overheating and drying.

Additionally, through moisture absorption and heat dissipation using the thermochemical reaction, it is possible to reduce generation of condensate water in the fuel cell stack in a low-temperature section, and alleviate output power limitations to prevent excessive generation of condensate water.

The effects of the present disclosure are not limited to those mentioned above, and other effects not mentioned will be clearly understood by those skilled in the art from the description provided hereinafter.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating the configuration of a fuel cell system according to an embodiment of the present disclosure;

FIGS. 2 and 3 are views illustrating a thermochemical reaction in the heat energy storage part according to an embodiment of the present disclosure;

FIG. 4 is a view illustrating an operation process of the fuel cell system according to an embodiment of the present disclosure; and

FIG. 5 is a flowchart illustrating a control process of the fuel cell system according to an embodiment of the present disclosure.

### DETAILED DESCRIPTION

Specific structural and functional descriptions of embodiments of the present disclosure disclosed herein are only for illustrative purposes of the embodiments of the present disclosure. The present disclosure may be embodied in many different forms without departing from the spirit and significant characteristics of the present disclosure.

Reference will now be made in detail to various embodiments of the present disclosure, specific examples of which are illustrated in the accompanying drawings and described below, since the embodiments of the present disclosure can be variously modified in many different forms. While the present disclosure will be described in conjunction with exemplary embodiments thereof, it is to be understood that the present description is not intended to limit the present disclosure to those exemplary embodiments. On the contrary, the present disclosure is intended to cover not only the exemplary embodiments, but also various alternatives, modifications, equivalents and other embodiments that may be included within the spirit and scope of the present disclosure as defined by the appended claims.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

Hereinafter, embodiments disclosed in the present disclosure will be described in detail with reference to the accompanying drawings, in which identical or similar constituent elements are given the same reference numerals regardless of the reference numerals of the drawings, and repeated description thereof will be omitted.

In the following description of the embodiments, when a parameter is referred to as being “preset”, it may be intended to mean that a value of the parameter is determined in advance when the parameter is used in a process or an algorithm. The value of the parameter may be set when the process or the algorithm starts or may be set during a section that the process or the algorithm is executed.

The element suffixes “module” and “part” used in the following description are given or mixed together only considering the ease of creating the specification, and have no meanings or roles that are distinguished from each other by themselves.

In the following description, when it is determined that the detailed description of the related art would obscure the gist of the present disclosure, the detailed description thereof will be omitted. In addition, the accompanying drawings are merely intended to be able to readily understand the embodiments disclosed herein, and thus the technical idea disclosed herein is not limited by the accompanying drawings, and it should be understood to include all changes, equivalents, and substitutions included in the idea and technical scope of the present disclosure.

It will be understood that, although the terms “first”, “second”, and other similar terms, may be used herein to describe various elements, these elements should not be limited by these terms. These terms are only used to distinguish one element from another element.

It will be understood that when an element is referred to as being “coupled”, “connected”, or “linked” to another element, it can be directly coupled or connected to the other element or intervening elements may be present therebetween. In contrast, it should be understood that when an element is referred to as being “directly coupled”, “directly connected”, or “directly linked” to another element, there are no intervening elements present.

As used herein, the singular forms are intended to include the plural forms as well, unless the context clearly indicates otherwise.

It will be further understood that the terms “comprise”, “include”, and “have”, when used in this specification, specify the presence of stated features, integers, steps, operations, elements, components, and/or combinations thereof but do not preclude the presence or addition of one or more other features, integers, steps, operations, elements, components, and/or combinations thereof.

In addition, the term “unit” or “control unit” included in, for example, fuel cell control unit (FCU), motor control unit (MCU), and hybrid control unit (HCU), may be widely used to refer to a controller for controlling a specific function of a vehicle, but may not mean a generic functional unit.

For example, each controller may include a communication device communicating with another controller or a sensor to control a corresponding function to which the controller is in charge, a memory storing an operating system (OS), logic commands, input/output information, and the like, and one or more processors performing determination, calculation, decision, and the like required for the control of the corresponding function.

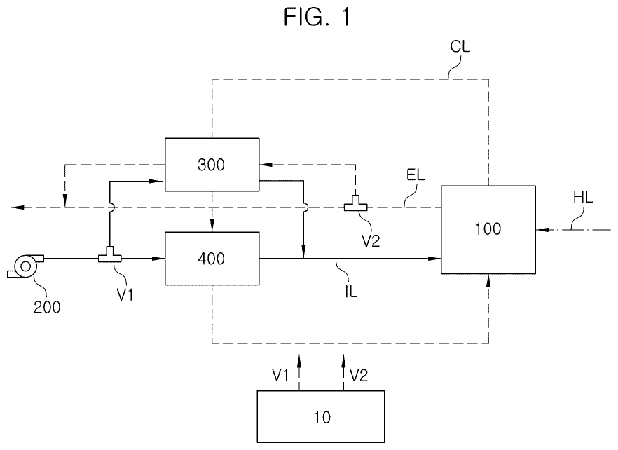

FIG. 1 is a view illustrating the configuration of a fuel cell system according to an embodiment of the present disclosure.

Referring to FIG. 1, the fuel cell system according to the embodiment of the present disclosure includes a fuel cell stack 100, an air compressor 200, a heat energy storage part 300, a heat exchanger 400, and a controller 10. However, FIG. 1 mainly illustrates elements related to the description of the embodiment of the present disclosure, and an actual fuel cell system may be implemented by including more or fewer elements.

First, the fuel cell stack 100 may generate power by converting chemical energy into electrical energy through an electrochemical reaction using an oxidation-reduction reaction between supplied hydrogen and oxygen. To this end, the fuel cell stack 100 may include at least one fuel cell having an anode and a cathode, and an electrolyte membrane may be provided between the anode and the cathode in the fuel cell.

The fuel cell stack 100 may be connected to an intake line IL through which air is introduced and an exhaust line EL through which air is discharged. More specifically, the intake line IL and the exhaust line EL may be connected to the cathode of the fuel cell stack 100. Additionally, a hydrogen supply line HL may be connected to the anode of the fuel cell stack 100.

The air compressor 200 may be connected to a second end of the intake line IL having a first end connected to the fuel cell stack 100. The air compressor 200 may compress air from the outside and supply compressed air to the fuel cell stack 100. Here, the term “outside” refers to the outside of the fuel cell system, for example, may refer to the outside of a vehicle equipped with a fuel cell system, and may have the same meaning in the following descriptions.

The air compressor 200 may be provided with a driving part such as a motor to supply compressed air to the fuel cell stack 100. In the following description, a driving speed of the air compressor 200 may refer to a driving speed of a motor provided in the air compressor 200. Meanwhile, the heat energy storage part 300 may be provided between the fuel cell

stack 100 and the air compressor 200 on the intake line IL, and may absorb and store heat from the air on the intake line IL through a thermochemical reaction and release moisture into the air on the intake line IL.

Additionally, the heat energy storage part 300 may be connected to the exhaust line EL, may be provided on a coolant line CL through which a coolant for cooling the fuel cell stack 100 flows, and may absorb moisture from the air on the exhaust line EL through a thermochemical reaction and release stored heat into the coolant.

That is, in one embodiment, the air on the intake line IL, the air on the exhaust line EL, and the coolant on the coolant line CL may all pass through the heat energy storage part 300, and the heat energy storage part 300 may exchange heat or moisture with the air on the intake line IL, the air on the exhaust line EL, and the coolant on the coolant line CL.

The heat energy storage part 300 according to one embodiment may be implemented as a thermochemical energy storage (TCES) system that can absorb and store surrounding heat through physical/chemical combination of materials and release the stored heat again.

The heat exchanger 400 may be disposed in parallel with the heat energy storage part 300 on the intake line IL between the fuel cell stack 100 and the air compressor 200, and may be provided on the coolant line CL. Therefore, heat exchange between the coolant on the coolant line CL and the air on the intake line CL may occur in the heat exchanger 400. The heat exchanger 400 may be implemented as, for example, a water-cooled cooler. In this case, the heat energy storage part 300 and the heat exchanger 400 may be arranged in series on the coolant line CL, and a coolant tank in which the coolant is stored, a pump for circulating the coolant, a heater for raising the temperature of the coolant, and the like may be further provided on the coolant line CL.

In particular, the heat energy storage part 300 may be disposed in front of the heat exchanger 400 in a flow direction of the coolant. In this case, in the heat exchanger 400, the coolant whose temperature is raised through the thermochemical reaction in the heat energy storage part 300 may be used for heat exchange.

Both the heat energy storage part 300 and the heat exchanger 400 may be used to cool the air supplied from the air compressor 200 to the fuel cell stack 100, but there is a difference in that the heat energy storage part 300 cools the air supplied to the fuel cell stack 100 through heat absorption and storage through physical/chemical reactions of materials, while the heat exchanger 400 cools the air supplied to the fuel cell stack 100 through heat exchange between the coolant and air.

Meanwhile, a first valve V1 that is provided between the air compressor 200 and the heat energy storage part 300 and selectively connects the air compressor 200 and the heat energy storage part 300 depending on its opening state may be provided on the intake line IL. For example, the first valve V1 may connect the air compressor 200 and the heat energy storage part 300 in an opened state to allow air flow between the air compressor 200 and the heat energy storage part 300, and may disconnect the air compressor 200 and the heat energy storage part 300 in a closed state to block air flow between the air compressor 200 and the heat energy storage part 300.

In this case, the thermochemical reaction in the heat energy storage part 300 may occur when the air compressor 200 and the heat energy storage part 300 are connected to each other through the first valve V1 and air flow therebetween is allowed.

Additionally, the first valve V1 may connect the air compressor 200 to at least one of the heat energy storage part 300 and the heat exchanger 400 on the intake line IL depending on its opening state. To this end, the first valve V1 may include a plurality of openings. In this case, respective openings may be connected to an air outlet end of the air compressor 200, an air inlet end of the heat energy storage part 300, and an air inlet end of the heat exchanger 400.

According to the first valve V1 as described above, the air compressor 200 may be connected to the heat energy storage part 300 or the heat exchanger 400 or may be connected to both the heat energy storage part 300 and the heat exchanger 400. Here, when the air compressor 200 is connected to the heat energy storage part 300, the air on the intake line IL may be cooled through the thermochemical reaction in the heat energy storage part 300 and introduced into the fuel cell stack 100 with obtained moisture resulting from the thermochemical reaction. When the air compressor 200 is connected to the heat energy storage part 300, the air on the intake line IL may be cooled through heat exchange with the coolant in the heat exchanger 400.

A second valve V2 that is provided between the fuel cell stack 100 and the heat energy storage part 300 and selectively connects the fuel cell stack 100 and the heat energy storage part 300 depending on its opening state may be provided on the exhaust line EL. For example, the second valve V2 may connect the fuel cell stack 100 and the heat energy storage part 300 in an opened state to allow air flow between the fuel cell stack 100 and the heat energy storage part 300, and may disconnect the fuel cell stack 100 and the heat energy storage part 300 in a closed state to block air flow between the fuel cell stack 100 and the heat energy storage part 300.

In this case, the thermochemical reaction in the heat energy storage part 300 may occur when the fuel cell stack 100 and the heat energy storage part 300 are connected to each other through the second valve V2 and air flow therebetween is allowed.

Additionally, the second valve V2 may form a path through which the air on the exhaust line EL is discharged by bypassing the heat energy storage part 300 depending on its opening state. As in the example above, in its closed state, the second valve V2 may block air flow between the fuel cell stack 100 and the heat energy storage part 300 by disconnecting the fuel cell stack 100 and the heat energy storage part 30, and at the same time, allow air flow to the outside so that the air discharged from the fuel cell stack 100 is discharged directly to the outside without bypassing the heat energy storage part 300. To this end, the second valve V2 may include a plurality of openings. In this case, respective openings may be connected to an air outlet end of the fuel cell stack 100, the air inlet end of the heat energy storage part 300, and an external outlet end of the exhaust line EL.

Here, when the fuel cell stack 100 is connected to the heat energy storage part 300, the heat energy storage part 300 may obtain moisture from the air on the exhaust line EL and discharge stored heat, and the discharged heat may be transferred to the coolant on the coolant line CL and the air on the exhaust line EL. On the contrary, when the air on the exhaust line EL is discharged by bypassing the heat energy storage part 300, the heat energy storage part 300 does not affect the coolant on the coolant line CL and the air on the exhaust line EL.

Meanwhile, the controller 10 may control the thermochemical reaction in the heat energy storage part 300 by controlling opening states of the first valve V1 and the second valve V2 described above.

More specifically, the controller 10 may control the opening state of the first valve V1 based on a driving speed of the air compressor 200, thereby controlling the thermochemical reaction through the air on the intake line IL.

For example, when the driving speed of the air compressor 200 is equal to or greater than a preset first reference speed, the controller 10 may control the opening state of the first valve V1 so that the air compressor 200 and the heat energy storage part 300 are connected to each other on the intake line IL.

Here, the first reference speed is a criteria for determining whether the fuel cell stack 100 is operating in a high-output power section, and is due to the fact that in the high-output power section, the air compressor 200 operates at high speed to supply more air to increase output power. For example, the first reference speed may be set to a value of 80% of a maximum drivable speed of the air compressor 200.

Thereby, in the high-output power section of the fuel cell stack 100, the controller 10 may allow air heated and dried by compression heat of the air compressor 200 driven at high speed to be introduced into the heat energy storage part 300, and allow air that absorbs heat and receives moisture through the thermochemical reaction to be supplied to the fuel cell stack 100. As a result, heating and drying of the fuel cell stack 100 may be alleviated in the high-output power section, and output power limitations to prevent heating and drying may be alleviated, thereby allowing the fuel cell stack 100 to produce higher output power.

Meanwhile, during a continuous thermochemical reaction process, there may occur a state in which no more heat is stored in the heat energy storage part 300. In this case, cooling and moisture supply to the air on the intake line IL through thermochemical reaction may be limited, but since the heat energy storage part 300 is disposed on the intake line IL and the coolant line CL, the air on the intake line IL may be cooled through heat exchange with the coolant in the heat energy storage part 300.

Such a state in which the air compressor 200 and the heat energy storage part 300 are connected to each other on the intake line IL through the first valve V1 may not be maintained. For example, when the driving speed of the air compressor 200 is less than a preset second reference speed, the controller 10 may control the opening state of the first valve V1 so that the air compressor 200 and the heat energy storage part 300 are disconnected from each other on the intake line IL.

Here, the second reference speed is a criteria for determining whether to maintain or terminate temperature and humidity control of the air on the intake line IL through the thermochemical reaction, has a value equal to or less than the first reference speed, and may be set, for example, to a value of 50% of the maximum drivable speed of the air compressor 200. When the driving speed of the air compressor 200 is less than the preset second reference speed, the controller 10 may determine that compression heat of the air compressor 200 is at an appropriate level for operation of the fuel cell system, and allow the air compressor 200 and the heat energy storage part 300 to be disconnected from each other and compressed air discharged from the air compressor 200 to be directly supplied to the fuel cell stack 100.

Additionally, regardless of the driving speed of the air compressor 200, when a preset time elapses after the air compressor 200 and the heat energy storage part 300 are connected to each other on the intake line IL, the controller 10 may control the opening state of the first valve V1 so that the air compressor 200 and the heat energy storage part 300 are disconnected from each other on the intake line IL. In this case, the preset time may be set based on a heat storage capacity of the heat energy storage part 300, a reaction rate of the thermochemical reaction, or the like.

Meanwhile, the controller 10 may control the opening state of the second valve V2 based on a temperature of the coolant, thereby controlling the thermochemical reaction through the air on the exhaust line EL.

For example, when the temperature of the coolant is less than a preset first reference temperature, the controller 10 may control the opening state of the second valve V2 so that the fuel cell stack 100 and the heat energy storage part 300 are connected to each other on the exhaust line EL.

Here, the temperature of the coolant, which represents the temperature of the fuel cell stack 100 as it exchanges heat with the fuel cell stack 100, is the subject of judgment. The first reference temperature is a criteria for determining whether the fuel cell stack 100 is operating in a low-temperature operation section, and may be, for example, 20° C. In this case, when the temperature of the coolant is less than the first reference temperature, the fuel cell stack 100 may be considered to be operating in a low-temperature section.

Thereby, in the low-temperature operation section of the fuel cell stack 100, the controller 10 may allow moisture to be absorbed from low-temperature moist air discharged from the fuel cell stack 100 and heat to be discharged, thereby raising the temperature of the coolant. Through heat exchange with the coolant with a raised temperature, the fuel cell stack 100, which was operating in the low-temperature section, may operate in a relatively raised temperature section, and excessive generation of condensate water inside the fuel cell stack 100 caused by low temperature operation may be alleviated. Additionally, output power limitations to prevent excessive generation of condensate water may also be alleviated, thereby allowing the fuel cell stack 100 to produce higher output power even in the low-temperature section.

Meanwhile, when the heat energy storage part 300 is in a state of absorbing and storing heat from the air on the intake line IL, the controller 10 may control the opening state of the second valve V2 so that the fuel cell stack 100 and the heat energy storage part 300 are connected to each other on the exhaust line EL.

That is, the controller 10 may connect the fuel cell stack 100 and the heat energy storage part 300 on the exhaust line EL by assuming that heat stored in the heat energy storage part 300 exists. In this case, whether the heat energy storage part 300 is in a state of absorbing and storing heat from the air on the intake line IL may be determined based on a heat storage amount of the heat energy storage part 300, or may be determined based on connection history between the air compressor 200 and the heat energy storage part 300 through the first valve V1.

Meanwhile, unlike this, the controller 10 may control the opening state of the second valve V2 so that the fuel cell stack 100 and the heat energy storage part 300 are connected to each other on the exhaust line EL, regardless of whether the heat energy storage part 300 is in a state of absorbing and storing heat from the air on the intake line IL. In this case, even in a state in which there is no heat stored in the heat energy storage part 300, when the fuel cell stack 100 and the heat energy storage part 300 are connected to each other through the second valve V2, there may be formed an air discharge path with a higher differential pressure compared to a path in which air bypasses the heat energy storage part 300 and is discharged directly to the outside. With this, the driving speed of the air compressor 200 may be increased, and the temperature of the coolant and the fuel cell stack 100 may be raised through resulting compression heat.

Meanwhile, when the temperature of the coolant is equal to or greater than a preset second reference temperature, the controller 10 may control the opening state of the second valve V2 so that the fuel cell stack 100 and the heat energy storage part 300 are disconnected from each other on the exhaust line EL.

Here, the second reference temperature may be set to a value equal to or greater than the first reference temperature.

Here, the second reference temperature is a criteria for determining whether to maintain or terminate raising the temperature of the coolant through the thermochemical reaction, and may be set to a value equal to or greater than the first reference temperature, for example, 55° C. When the temperature of the coolant is equal to or greater than the second reference temperature, the controller 10 may determine that the fuel cell stack 100 is operating in an appropriate temperature section, and allow the fuel cell stack 100 and the heat energy storage part 300 to be disconnected from each other and the air discharged from the fuel cell stack 100 to be immediately discharged to the outside.

Additionally, regardless of the temperature of the coolant, when a preset time elapses after the fuel cell stack 100 and the heat energy storage part 300 are connected to each other on the exhaust line EL, the controller 10 may control the opening state of the second valve V2 so that the fuel cell stack 100 and the heat energy storage part 300 are disconnected from each other on the exhaust line EL. In this case, the preset time may be set based on a heat storage capacity of the heat energy storage part 300, a reaction rate of the thermochemical reaction, or the like.

Meanwhile, in the embodiment described above, the opening state of the first valve V1 is controlled based on the driving speed of the air compressor 200, but in another embodiment, the opening state of the first valve V1 may be controlled based on the temperature of the coolant.

For example, when the temperature of the coolant increases, the controller 10 may control the opening state of the first valve V1 so that the air compressor 200 and the heat energy storage part 300 are connected to each other on the intake line IL, and when the temperature of the coolant decreases, the controller 10 may control the opening state of the first valve V1 so that the air compressor 200 and the heat energy storage part 300 are disconnected from each other on the intake line IL.

Likewise, in the embodiment described above, the opening state of the second valve V2 is controlled based on the temperature of the coolant, but in another embodiment, the opening state of the second valve V2 may be controlled based on the driving speed of the air compressor 200.

For example, when the driving speed of the air compressor 200 decreases, the controller 10 may control the opening state of the second valve V2 so that the fuel cell stack 100 and the heat energy storage part 300 are connected to each other on the exhaust line EL, and when the driving speed of the air compressor 200 increases, the controller 10 may control the opening state of the second valve V2 so that the fuel cell stack 100 and the heat energy storage part 300 are disconnected from each other on the exhaust line EL.

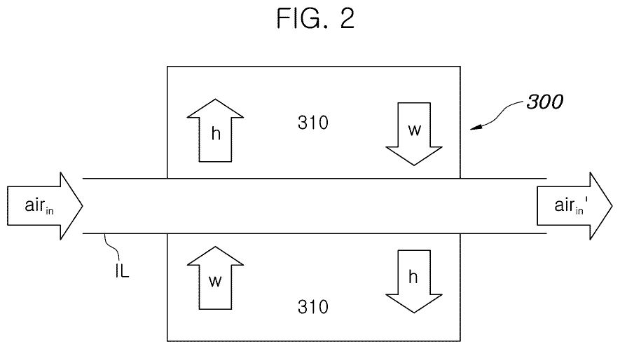

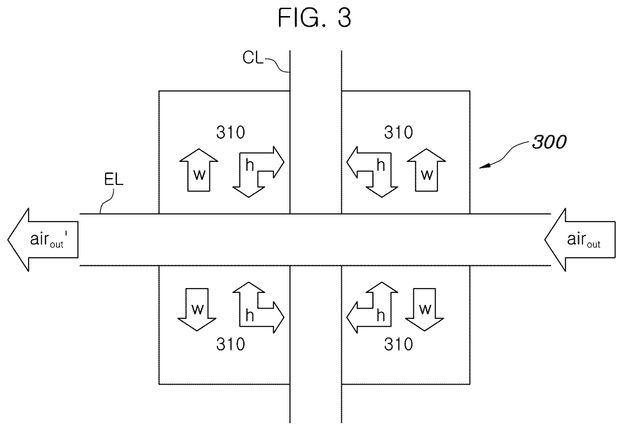

Hereinafter, a thermochemical reaction that occurs in the heat energy storage part 300 will be described with reference to FIGS. 2 and 3.

FIGS. 2 and 3 are views illustrating a thermochemical reaction in the heat energy storage part 300 according to an embodiment of the present disclosure.

Referring to FIGS. 2 and 3, the inside of the heat energy storage part 300 may be filled with salt 310, which a material that bonds physically and chemically for thermochemical storage. The salt 310 may undergo a thermochemical reaction with the air on the intake line IL and the exhaust line EL to absorb or release heat/moisture. This thermochemical reaction may be expressed as a reaction equation as follows.

Salt·xH₂O₍ₛ₎+ΔH⇔Salt·(x−y)H₂O₍ₛ₎+yH₂O_{(g)}

Here, salt refers to the salt 310, x and y refer to a binding ratio determined according to the type of salt 310, and ΔH refers to heat energy. Within the heat energy storage part 300, the salt 310 exists in a moisture-adsorbed state (salt·xH₂O(ₛ)) (e.g., wherein “s” refers to a solid), and when heat energy (ΔH) is applied thereto, the salt 310 absorbs and stores heat energy (ΔH) and releases moisture (yH₂O(_{g})) (e.g., wherein “g” refers to a gas). On the contrary, when moisture (yH₂O(_{g})) is applied, the salt 310 absorbs moisture (yH₂O(_{g})) while releasing heat energy (ΔH).

Referring to FIG. 2, when hot and dry air airᵢₙ (e.g., wherein airᵢₙ is dry air with high temperature) from the air compressor 200 flows into the intake line IL, the heat energy storage part 300 absorbs heat h and releases moisture w through a thermochemical reaction between the salt 310 and heat in the air airᵢₙ, thereby allowing cooled and moistened air airᵢₙ′ to flow into the fuel cell stack 100.

Referring to FIG. 3, when cool and moist air airₒᵤₜ (e.g., wherein ‘airₒᵤₜ’ is moist air with low temperature) from the fuel cell stack 100 flows into the exhaust line EL, the heat energy storage part 300 releases heat h and absorbs moisture w through a thermochemical reaction between the salt 310 and moisture in the air airₒᵤₜ. In this process, the coolant on the coolant line CL is heated through the released heat h and heated and moistened air airₒᵤₜ′ is discharged from the exhaust line EL.

Meanwhile, the salt 310 may be implemented as various types of compounds and may be selected in consideration of an operating environment of the fuel cell stack 100. Selection of the salt 310 may be made by considering a temperature range at which the thermochemical reaction of the salt 310 occurs, an upper limit operating temperature of the fuel cell stack 100, an energy capacity of the salt 310, a heat capacity of a cooling system for cooling the fuel cell stack 100, an operating temperature range of the fuel cell stack 100, or the like. For example, the salt 310 may be implemented as lithium hydroxide (LiOH).

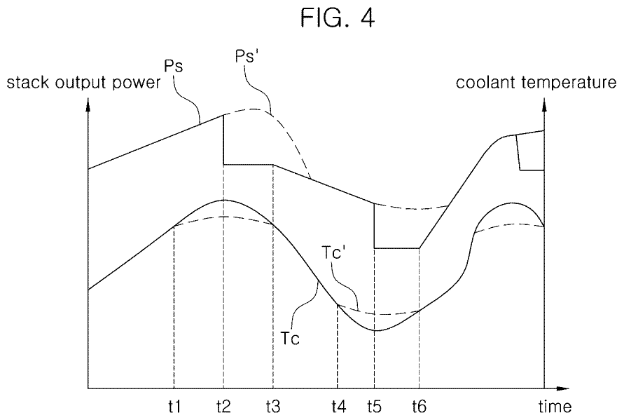

Hereinafter, an operation process of the fuel cell system described so far will be described with reference to FIG. 4.

FIG. 4 is a view illustrating an operation process of the fuel cell system according to an embodiment of the present disclosure.

Referring to FIG. 4, there is illustrated a graph with time on the horizontal axis and stack output power and coolant temperature on the vertical axis.

Each curve represents a stack output power Ps and a coolant temperature Tc when no thermochemical reaction is involved, and a stack output power Ps′ and a coolant temperature Tc′ when a thermochemical reaction is involved.

In a t1-t3 section on the graph, the controller 10 allows the air compressor 200 and the heat energy storage part 300 to be connected to each other through the first valve V1, resulting in that the high-temperature dry air on the intake line IL is cooled through the thermochemical reaction and obtains moisture. Accordingly, the coolant temperature Tc′ becomes lower than the coolant temperature Tc when no thermochemical reaction is involved, and even in a t2-t3 section, the stack output power Ps′ may not be limited unlike the stack output power Ps when no thermochemical reaction is involved.

In a t4-t6 section on the graph, the controller 10 allows the fuel cell stack 100 and the heat energy storage part 300 to be connected to each other through the second valve V2, resulting in that the temperature of the coolant on the coolant line CL is raised. Accordingly, the coolant temperature Tc′ becomes higher than the coolant temperature Tc when no thermochemical reaction is involved, and even in a t5-t6 section, the stack output power Ps′ may not be limited unlike the stack output power Ps when no thermochemical reaction is involved.

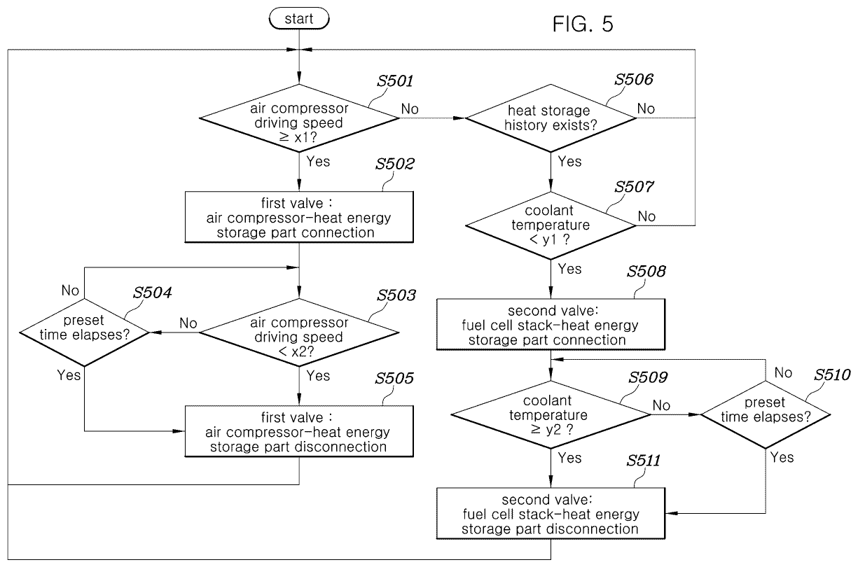

Hereinafter, a control process of the fuel cell system described so far will be described with reference to FIG. 5.

FIG. 5 is a flowchart illustrating a control process of the fuel cell system according to an embodiment of the present disclosure.

Referring to FIG. 5, during operation of the fuel cell system, when the driving speed of the air compressor 200 is equal to or greater than the preset first reference speed x1 (Yes in S501), the controller 10 controls the opening state of the first valve V1 so that the air compressor 200 and the heat energy storage part 300 are connected to each other on the intake line IL (S502).

Then, when the driving speed of the air compressor is less than the preset second reference speed x2 (Yes in S503) or the preset time elapses after the air compressor 200 and the heat energy storage part 300 are connected to each other on the intake line IL (Yes in S504), the controller 10 controls the opening state of the first valve V1 so that the air compressor 200 and the heat energy storage part 300 are disconnected from each other on the intake line IL (S505).

Meanwhile, during operation of the fuel cell system, when the driving speed of the air compressor 200 is less than the preset first reference speed x1 (No in S501) and there is a heat storage history of the heat energy storage part 300 exists (Yes in S506), the controller 10 controls the opening state of the second valve V2 based on the temperature of the coolant (S507).

In this case, when the temperature of the coolant is less than the preset first reference temperature y1 (Yes in S507), the controller 10 controls the opening state of the second valve V2 so that the fuel cell stack 100 and the heat energy storage part 300 are connected to each other on the exhaust line EL (S508).

Then, when the temperature of the coolant is equal to or greater than the preset second reference temperature y2 (Yes in S509) or the preset time elapses after the fuel cell stack 100 and the heat energy storage part 300 are connected to each other on the exhaust line EL (Yes in S510), the controller 10 controls the opening state of the second valve V2 so that the fuel cell stack 100 and the heat energy storage part 300 are disconnected from each other on the exhaust line EL (S511).

According to various embodiments of the present disclosure as described above, it is possible to efficiently manage an operating environment of the fuel cell stack through the thermochemical reaction.

In particular, through heat absorption and moisture release using the thermochemical reaction, it is possible to alleviate overheating and drying of the fuel cell stack in the high-output power section, and alleviate output power limitations to prevent overheating and drying.

Additionally, through moisture absorption and heat dissipation using the thermochemical reaction, it is possible to reduce generation of condensate water in the fuel cell stack in the low-temperature section, and alleviate output power limitations to prevent excessive generation of condensate water.

Although specific embodiments of the present disclosure have been described for illustrative purposes, those skilled in the art will appreciate that various modifications, additions, and substitutions are possible, without departing from the scope and spirit of the present disclosure as disclosed in the appended claims.

What is claimed is:

1. A fuel cell system, comprising:
a fuel cell stack connected to an intake line through which air is introduced and an exhaust line through which air is discharged;
an air compressor connected to the intake line, and configured to compress external air and supply the compressed external air to the fuel cell stack; and
a heat energy storage part provided on the intake line between the fuel cell stack and the air compressor, and configured to absorb and store heat from the air on the intake line through a thermochemical reaction and release moisture into the air on the intake line.

2. The fuel cell system of claim 1, further comprising
a first valve provided on the intake line between the air compressor and the heat energy storage part and selectively connects the air compressor and the heat energy storage part depending on an opening state of the first valve.

3. The fuel cell system of claim 2, further comprising
a controller configured to control the opening state of the first valve based on a driving speed of the air compressor.

4. The fuel cell system of claim 3, wherein when the driving speed of the air compressor is equal to or greater than a preset first reference speed, the controller controls the opening state of the first valve so that the air compressor and the heat energy storage part are connected to each other on the intake line.

5. The fuel cell system of claim 4, wherein when the driving speed of the air compressor is less than a preset second reference speed that is preset to a value equal to or less than the first reference speed, the controller controls the opening state of the first valve so that the air compressor and the heat energy storage part are disconnected from each other on the intake line.

6. The fuel cell system of claim 3, wherein when a preset time elapses after the air compressor and the heat energy storage part are connected to each other on the intake line, the controller controls the opening state of the first valve so that the air compressor and the heat energy storage part are disconnected from each other on the intake line.

7. The fuel cell system of claim 2, further comprising
a heat exchanger disposed in parallel with the heat energy storage part on the intake line between the fuel cell stack and the air compressor,
wherein the first valve connects the air compressor to at least one of the heat energy storage part and the heat exchanger on the intake line depending on the opening state of the first valve.

8. The fuel cell system of claim 7, wherein the heat energy storage part and the heat exchanger are arranged in series on a coolant line through which a coolant for cooling the fuel cell stack flows.

9. The fuel cell system of claim 1, wherein the heat energy storage part is connected to the exhaust line, is provided on a coolant line through which a coolant for cooling the fuel cell stack flows, and absorbs moisture from the air on the exhaust line through the thermochemical reaction and releases the stored heat into the coolant.

10. The fuel cell system of claim 9, further comprising
a second valve provided on the exhaust line between the fuel cell stack and the heat energy storage part exhaust and selectively connects the fuel cell stack and the heat energy storage part depending on an opening state of the second valve.

11. The fuel cell system of claim 10, further comprising
a controller configured to control the opening state of the second valve based on a temperature of the coolant.

12. The fuel cell system of claim 11, wherein when the temperature of the coolant is less than a preset first reference temperature, the controller controls the opening state of the second valve so that the fuel cell stack and the heat energy storage part are connected to each other on the exhaust line.

13. The fuel cell system of claim 11, wherein when the heat energy storage part is in a state of absorbing and storing heat from the air on the intake line, the controller controls the opening state of the second valve so that the fuel cell stack and the heat energy storage part are connected to each other on the exhaust line.

14. The fuel cell system of claim 12, wherein when the temperature of the coolant is equal to or greater than a preset second reference temperature that is preset to a value equal to or greater than the first reference temperature, the controller controls the opening state of the second valve so that the fuel cell stack and the heat energy storage part are disconnected from each other on the exhaust line.

15. The fuel cell system of claim 11, wherein when a preset time elapses after the fuel cell stack and the heat energy storage part are connected to each other on the exhaust line, the controller controls the opening state of the second valve so that the fuel cell stack and the heat energy storage part are disconnected from each other on the exhaust line.

16. The fuel cell system of claim 10, wherein the second valve forms a path through which the air on the exhaust line is discharged by bypassing the heat energy storage part depending on the opening state of the second valve.

17. The fuel cell system of claim 9, further comprising
a heat exchanger disposed in series with the heat energy storage part on the coolant line,
wherein the heat energy storage part is disposed in front of the heat exchanger in a flow direction of the coolant.

18. The fuel cell system of claim 1, wherein the thermochemical reaction occurs through lithium hydroxide (LiOH) filled inside the heat energy storage part.
